(19) United States
(12) Patent Application Publication
(10) Pub. No.: US 2021/0173729 A1
(43) Pub. Date: Jun. 10, 2021

(54) SYSTEMS AND METHODS OF APPLICATION PROGRAM INTERFACE (API) PARAMETER MONITORING

(71) Applicant: salesforce.com, inc., San Francisco, CA (US)

(72) Inventors: Philippe Riand, Burlington, MA (US); Jeremiah David Brazeau, Hudson, NH (US)

(21) Appl. No.: 16/707,080

(22) Filed: Dec. 9, 2019

(51) Int. Cl. G06F 9/54

(52) U.S. Cl. CPC G06F 9/547

(57) ABSTRACT

Systems and methods are provided for receiving a request for data from at least one service available via an Application Program Interface (API), and determining a Uniform Resource Locator (URL) for the at least one service based on the received request. One or more parameters may be generated based on the received request to monitor processing of the received request, and the generated one or more parameters may be added to the URL. The request for the data for the at least one service via the API may be processed based on the generated URL at a service provider system by discarding the one or more parameters added to the URL. The data retrieved by the processing of the request may be transmitted, and the added one or more parameters of the URL may be monitored by categorizing or filtering the received request.

### BACKGROUND

Some current systems have Application Program Interfaces (APIs) that pass parameters as part of a body of a request. When monitoring systems are paired with such systems, the request is monitored by parsing and processing the body of the request.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 shows an example method of processing a request for data for at least one service via an API (Application Program Interface) based on a generated URL (Uniform Request Locator), and monitoring parameters added to the URL request according to an implementation of the disclosed subject matter.

FIG. 2 shows an example method of processing a URL request including at least a first parameter defined in an API provided by the server and at least a second parameter not defined in the API according to an implementation of the disclosed subject matter.

FIG. 3 shows a computer system according to an implementation of the disclosed subject matter.

FIG. 4 shows a network configuration according to an implementation of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter may add one or more parameters to a Uniform Resource Locator (URL) to provide information to a monitoring system while being ignored by a service provider. That is, the parameters added to the URL may be ignored and/or discarded by an Application Programming Interface (API) when processing a query with a URL for a service to be provided, and the added parameters may be used by the monitoring system to categorize and/or filter the query and/or request without having to parse the API terms.

Current systems include APIs that pass their parameters as part of a body of a request, rather than passing a URL. Such arrangements make it difficult for a monitoring system to analyze requests because it requires the body of the request to be parsed and executed.

Implementations of the disclosed subject matter improve upon such systems by adding one or more parameters that may be ignored and/or discarded by the API, and that may be used by the monitoring system.

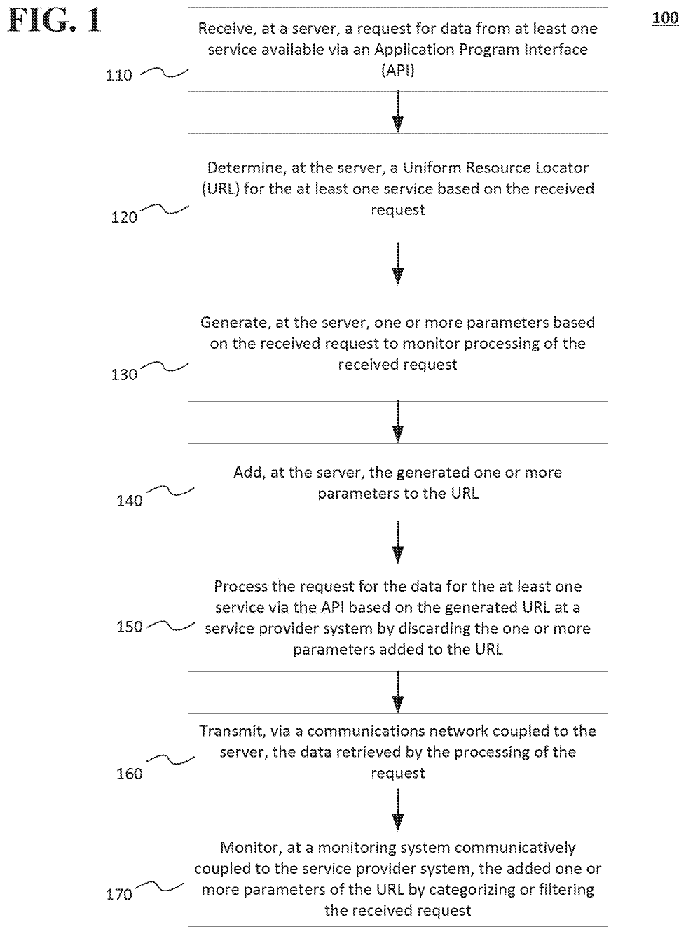

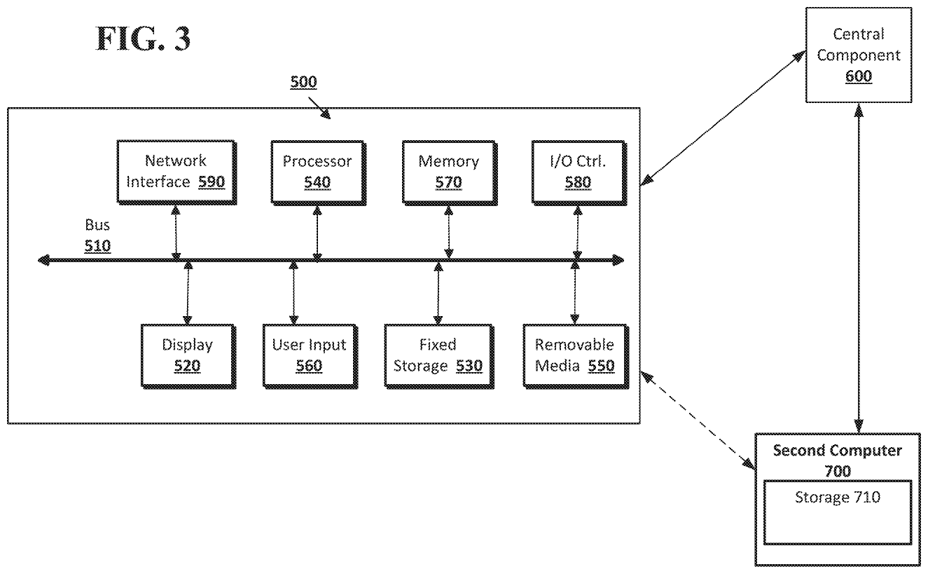

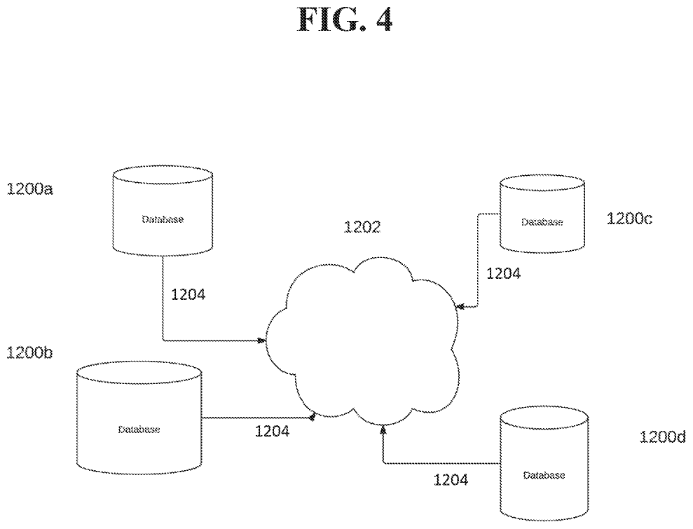

FIG. 1 shows an example method 100 of processing a request for data for at least one service via an API based on a generated URL, and monitoring parameters added to the URL request according to an implementation of the disclosed subject matter. At operation 110, a server (e.g., central component 600 and/or second computer 700 shown in FIG. 3, and/or database systems 1200a-d shown in FIG. 4) may receive a request for data from at least one service available via an Application Program Interface (API).

For example, the at least one service that data is requested from may be a micro-service, which is an arrangement of an application as a collection of loosely coupled services. In another example, the at least one service may be a web service provided by a website. In some implementations, the API may be for a data query and manipulation language which also responds to queries with existing data, such as GraphQL or the like. For example, implementations of the disclosed subject matter may decorate backend for frontend (BFF) GraphQL APIs (i.e., add one or more parameters to a generated URL to call the API) used in storefront applications, commerce applications, and/or other suitable applications.

At operation 120, the server may determine a URL for the at least one service based on the received request. For example, the server may generate a call to the API using the following generated URL: service/svc?query=1&val=200.

The server may generate one or more parameters based on the received request to monitor processing of the received request at operation 130. For example, the server may generate the parameter monitor_flag1=ABC&monitor_flag2=XYZ to monitor processing of the received request. At operation 140, the server may add the generated parameter to the URL. Continuing the example above, the parameters monitor_flag1=ABC&monitor_flag2=XYZ may be added to the URL service/svc?query=1&val=200 to form service/svc?query=1&val=200&monitor_flag1=ABC&monitor_flag2=XYZ. In some implementations, a client device (e.g., computer 500 shown in FIG. 3) may generate one or more of the parameters at operation 130, and/or a combination of the server and the client device may generate the one or more parameters at operation 130. In such implementations, the client device and/or the server may add the generated parameters to the URL. For example, the client device may generate one or more of the parameters for the URL, as the client device has context as to why the service is being called (e.g., based on an application running on the client, one or more user selections received, or the like). In some implementations, adding the one or more parameters may exceed a predetermined URL length. In order to address this, the server and/or client device may generate a unique identifier to be used as the one or more parameters. The server and/or client device may add the generated unique identifier to the URL.

In some implementations, the server and/or the client device may determine that adding the generated one or more parameters may exceed a predetermined URL length. In order to address this, the server and/or client device may generate a unique identifier to be used as the one or more parameters. The server and/or client device may add the generated unique identifier to the URL.

The server and/or client device may store the generated unique identifier that includes the one or more generated parameters at a storage device communicatively coupled to the server and/or the client device. The storage of the unique identifiers may form a “dictionary” or look-up-table, which may include the unique identifier and the corresponding values and/or parameters associated with the unique identifier. The unique identifier may be re-used each time the one or more parameters of the body match a previously seen set as stored in the dictionary and/or look-up-table.

When the adding the one or more parameters exceeds a predetermined URL length and the one or more parameters have been previously generated, the generated unique identifier may be retrieved from the storage device, and the server and/or client device may add the generated unique identifier to the URL.

The unique identifier may be generated by using a hash function without synchronization with the storage device. In some implementations, the hashing function may produce a unique key (i.e., a “fingerprint”). The fingerprint may be stored in the dictionary, and may be reproducible such that the unique identifier does not need to be synchronized (e.g., with the storage device, so that the references to the dictionary are with the same label). This implementation may save time when synchronizing writes from multiple concurrent callers to normalize on a value, as the fingerprint may be cached. With this implementation, a large set of values (e.g., the one or more parameters) may be condensed into the unique identifier, and the set of values may be available later when needed to provide the relevant information.

At operation 150, the request for the data for the at least one service via the API may be processed based on the generated URL at a service provider system (e.g., central component 600 and/or second computer 700 shown in FIG. 3, and/or database systems 1200a-d shown in FIG. 4) by discarding and/or ignoring the one or more parameters added to the URL. Continuing the example from above, the monitor_flag1=ABC&monitor_flag2=XYZ parameter may be discarded and/or ignored so that the remaining portion (i.e., service/svc?query=1&val=200) may be processed. In the implementations described above, where the client device and/or the server generates the URL, the service provider system may ignore and/or discard the one or more parameters added to the URL by the client device and/or server at operation 150. At operation 160, the data retrieved may be transmitted by the processing of the request.

At operation 170, the monitoring system (e.g., central component 600 and/or second computer 700 shown in FIG. 3) coupled to the service provider system may monitor the added one or more parameters of the URL by categorizing and/or filtering the received request. The monitoring system may categorize the one or more parameters into one or more categories, classifications, or the like. In some implementations, the monitoring system may filter the one or more parameters to determine which (if any) of the one or more parameters to monitor. In some implementations, the request may be categorized and/or filtered without parsing one or more terms of the URL for the API. In some implementations, the request may be categorized and/or filtered by a type of the at least one service. For example, the request may be categorized and/or filtered based on the micro-service requested, the web service requested, and/or REST (Representational State Transfer) services requested, or the like. In some implementations, the request may be categorized and/or filtered by one or more terms and/or parameters of the URL. For example, with the URL service/svc?query=1&val=200, the request may be categorized and/or filtered, for example, based on the parameter val=200.

In some implementations, the monitoring of operation 170 may include the monitoring system determining one or more errors with the request, a success of the request, and/or a time to complete the request. For example, one or more errors may result when requested data is not presently available from a service. The success of the request may be data, a parameter, flag, or the like to indicate that the request for data has been successfully processed and/or that the requested data has been provided. The time to complete the request may be a time period from receiving the request to providing the requested data. The determined results to be displayed in a monitoring report may be stored in a storage device (e.g., storage 710 shown in FIG. 3 and/or database systems 1200a-d shown in FIG. 4) communicatively coupled to the monitoring system. The monitoring report may be requested by a client device (e.g., computer 500 shown in FIG. 3), and may be displayed on a display communicatively coupled to the client device (e.g., display 520 shown in FIG. 3).

In some implementations, the monitoring of operation 170 may include having the monitoring system determine a utilization of the at least one service based on a percentage of time that the at least one service is busy, and/or the percentage capacity that the at least one service is in use. The determined utilization may be stored in a storage device (e.g., storage 710 shown in FIG. 3 and/or database systems 1200a-d shown in FIG. 4) communicatively coupled to the monitoring system to be displayed in the monitoring report.

The monitoring of operation 170 may include having the monitoring system determine a saturation of the at least one service, which is a measure of an amount of requested work. The determined saturation may be stored in a storage device (e.g., storage 710 shown in FIG. 3 and/or database systems 1200a-d shown in FIG. 4) communicatively coupled to the monitoring system to be displayed in the monitoring report.

In some implementations, the monitoring system may determine an availability of the at least one service that represents a percentage of time that the at least one service responds to the request as part of operation 170. The determined availability may be stored in a storage device (e.g., storage 710 shown in FIG. 3 and/or database systems 1200a-d shown in FIG. 4) communicatively coupled to the monitoring system to be displayed in the monitoring report.

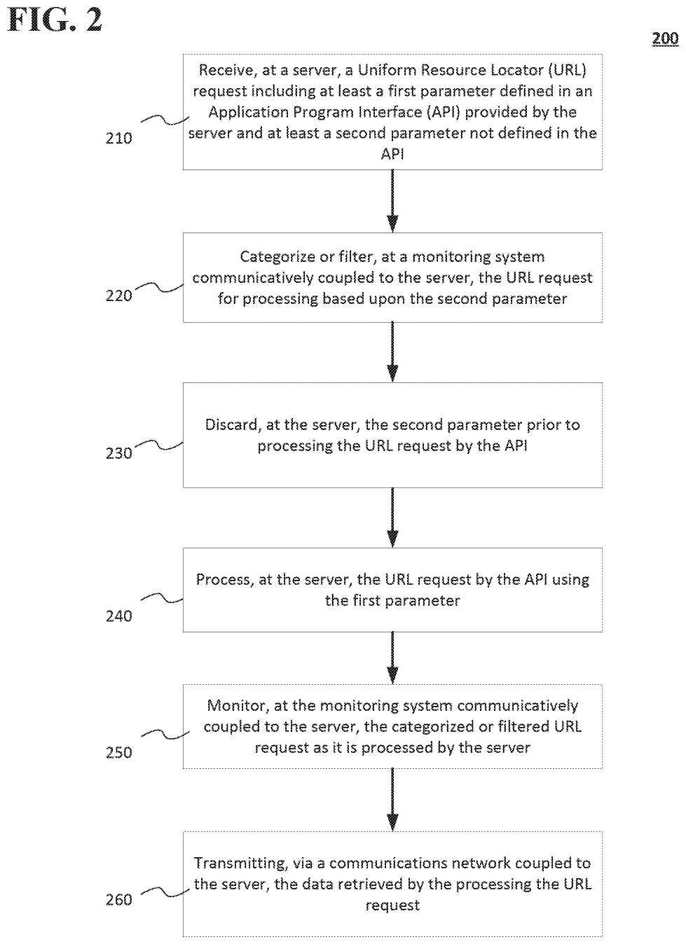

FIG. 2 shows an example method 200 for processing a URL request including at least a first parameter defined in an API provided by the server and at least a second parameter not defined in the API according to an implementation of the disclosed subject matter.

At operation 210, the server (e.g., central component 600 and/or second computer 700 shown in FIG. 3, and/or database systems 1200a-d shown in FIG. 4) may receive a URL request including at least a first parameter defined in an API provided by the server and at least a second parameter not defined in the API. For example, the first parameter may be part of a URL for the requested service, and the second parameter may be used by a monitoring system to monitor the request for the service.

At operation 220, the monitoring system (e.g., central component 600 and/or second computer 700 shown in FIG. 3) that is communicatively coupled to the server may categorize and/or filter the URL request for processing based upon the second parameter. The monitoring system may categorize the one or more parameters into one or more categories, classifications, or the like. In some implementations, the monitoring system may filter the one or more parameters to determine which (if any) of the one or more parameters to monitor. In some implementations, the request may be categorized and/or filtered by a type of service based on the second parameter. For example, the request may be categorized and/or filtered based on the micro-service requested, the web service requested, and/or REST (Representational State Transfer) services requested, or the like.

At operation 230, the server may discard and/or ignore the second parameter prior to processing the URL request by the API. The server may process the URL request by the API using the first parameter at operation 240. That is, in operations 230 and 240, the server may process the request based on the first parameter, while ignoring and/or discarding the second parameter.

At operation 250, the monitoring system that is communicatively coupled to the server may monitor the categorized and/or filtered URL request as it is processed by the server. The data retrieved by the processing the URL request may be transmitting, via a communications network coupled to the server at operation 260. As discussed above in connection with FIG. 1, the monitoring system may use the second parameter to determine: one or more errors with the request, a success of the request, a time to complete the request, a utilization of the at least one service based on a percentage of time that the at least one service is busy, the percentage capacity that the at least one service is in use, a saturation of the at least one service, and/or an availability of the at least one service that represents a percentage of time that the at least one service responds to the request.

Implementations of the presently disclosed subject matter may be implemented in and used with a variety of component and network architectures. FIG. 3 is an example computer 500 suitable for implementing implementations of the presently disclosed subject matter. As discussed in further detail herein, the computer 500 may be a single computer in a network of multiple computers. In some implementations, the computer 500 may be used to request data from one or more services, processing received data, and/or displaying a monitoring report. As shown in FIG. 4, the computer 500 may communicate with a central or distributed component 600 (e.g., server, cloud server, database, cluster, application server, neural network system, or the like). The central component 600 may communicate with one or more other computers such as the second computer 700, which may include a storage device 710. The storage 710 may use any suitable combination of any suitable volatile and non-volatile physical storage mediums, including, for example, hard disk drives, solid state drives, optical media, flash memory, tape drives, registers, and random access memory, or the like, or any combination thereof.

The storage 710 of the second computer 700 can store data (e.g., data that is part of one or more services, or the like). Further, if the systems shown in FIGS. 3-4 are multitenant systems, the storage can be organized into separate log structured merge trees for each instance of a database for a tenant. Alternatively, contents of all records on a particular server or system can be stored within a single log structured merge tree, in which case unique tenant identifiers associated with versions of records can be used to distinguish between data for each tenant as disclosed herein. More recent transactions can be stored at the highest or top level of the tree and older transactions can be stored at lower levels of the tree. Alternatively, the most recent transaction or version for each record (i.e., contents of each record) can be stored at the highest level of the tree and prior versions or prior transactions at lower levels of the tree.

The information obtained to and/or from a central component 600 can be isolated for each computer such that computer 500 cannot share information with central component 600 (e.g., for security and/or testing purposes). Alternatively, or in addition, computer 500 can communicate directly with the second computer 700.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks, as shown in FIGS. 3-4.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIGS. 3-4 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

FIG. 4 shows an example network arrangement according to an implementation of the disclosed subject matter. Four separate database systems 1200a-d at different nodes in the network represented by cloud 1202 communicate with each other through networking links 1204 and with users (not shown). The database systems 1200a-d may store, for example, data to be transmitted in response to a request from one or more services, data for monitoring reports, and the like. In some implementations, the one or more of the database systems 1200a-d may be located in different geographic locations. Each of database systems 1200 can be operable to host multiple instances of a database, where each instance is accessible only to users associated with a particular tenant. Each of the database systems can constitute a cluster of computers along with a storage area network (not shown), load balancers and backup servers along with firewalls, other security systems, and authentication systems. Some of the instances at any of database systems 1200a-d may be live or production instances processing and committing transactions received from users and/or developers, and/or from computing elements (not shown) for receiving and providing data for storage in the instances.

One or more of the database systems 1200a-d may include at least one storage device, such as in FIG. 4. For example, the storage can include memory 570, fixed storage 530, removable media 550, and/or a storage device included with the central component 600 and/or the second computer 700. The tenant can have tenant data stored in an immutable storage of the at least one storage device associated with a tenant identifier.

In some implementations, the one or more servers shown in FIGS. 3-4 can store the data (e.g., requested data that is part of a service, data for a monitoring report, and the like) in the immutable storage of the at least one storage device (e.g., a storage device associated with central component 600, the second computer 700, and/or the database systems 1200a-1200d) using a log-structured merge tree data structure.

The systems and methods of the disclosed subject matter can be for single tenancy and/or multitenancy systems. Multitenancy systems can allow various tenants, which can be, for example, developers, users, groups of users, and/or organizations, to access their own records (e.g., tenant data and the like) on the server system through software tools or instances on the server system that can be shared among the various tenants. The contents of records for each tenant can be part of a database containing that tenant. Contents of records for multiple tenants can all be stored together within the same database, but each tenant can only be able to access contents of records which belong to, or were created by, that tenant. This may allow a database system to enable multitenancy without having to store each tenants' contents of records separately, for example, on separate servers or server systems. The database for a tenant can be, for example, a relational database, hierarchical database, or any other suitable database type. All records stored on the server system can be stored in any suitable structure, including, for example, a log structured merge (LSM) tree.

Further, a multitenant system can have various tenant instances on server systems distributed throughout a network with a computing system at each node. The live or production database instance of each tenant may have its transactions processed at one computer system. The computing system for processing the transactions of that instance may also process transactions of other instances for other tenants.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “generating,” “adding,” “processing,” “transmitting,” “monitoring,” “categorizing,” “filtering,” “storing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

[43] More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
receiving, at a server, a request for data from at least one service available via an Application Program Interface (API);
determining, at the server, a Uniform Resource Locator (URL) for the at least one service based on the received request;
generating, at the server, one or more monitoring parameters for a monitoring system based on the received request to monitor processing of the received request;
adding, at the server, the generated one or more monitoring parameters to the URL;
processing the request for the data for the at least one service via the API based on the generated URL at a service provider system communicatively coupled to the monitoring system by discarding the one or more monitoring parameters for the monitoring system added to the URL and retrieving the requested data based on the processed request;
transmitting, via a communications network coupled to the server, the data retrieved by the processing of the request; and
monitoring, at the monitoring system, the added one or more monitoring parameters of the URL by categorizing or filtering the received request and outputting a monitoring report.

2. The method of claim 1, wherein the categorizing or filtering comprises:
categorizing or filtering the request without parsing one or more terms of the URL for the API.

3. The method of claim 1, wherein the categorizing or filtering comprises:
categorizing or filtering the request by a type of the at least one service.

4. The method of claim 1, further comprising:
when the adding the one or more parameters exceeds a predetermined URL length, generating, at the server, a unique identifier to be used as the one or more monitoring parameters; and
adding, at the server, the generated unique identifier to the URL.

5. The method of claim 4, further comprising:
storing, at a storage device communicatively coupled to the server, the generated unique identifier that includes the one or more generated monitoring parameters.

6. The method of claim 5, further comprising:
when the adding the one or more monitoring parameters exceeds a predetermined URL length and the one or more monitoring parameters have been previously generated, retrieving the generated unique identifier from the storage device; and
adding, at the server, the generated unique identifier to the URL.

7. The method of claim 5, wherein the generating the unique identifier comprises:
generating, at the server, the unique identifier using a hash function without synchronization with the storage device.

8. A method comprising:
receiving, at a server, a Uniform Resource Locator (URL) request including at least a first parameter defined in an Application Program Interface (API) provided by the server and at least a second parameter not defined in the API, wherein the second parameter is a monitoring parameter to be monitored by a monitoring system communicatively coupled to the server;
categorizing or filtering, at the monitoring system, the URL request for processing based upon the second parameter;
discarding, at the server, the second parameter prior to processing the URL request by the API;
retrieving data, at the server, by processing the URL request with the discarded second parameter by the API using the first parameter;
monitoring, at the monitoring system communicatively coupled to the server, the categorized or filtered URL request as it is processed by the server and outputting a monitoring report; and
transmitting, via a communications network coupled to the server, the data retrieved by the processing the URL request.

9. The method of claim 8, wherein the categorizing or filtering comprises:
categorizing or filtering the request by a type of service based on the second parameter.

10. A system comprising:
a server having a processor to receive a request for data from at least one service available via an Application Program Interface (API), to determine a Uniform Resource Locator (URL) for the at least one service based on the received request, to generate one or more monitoring parameters for a monitoring system based on the received request to monitor processing of the received request, and to add the generated one or more monitoring parameters to the URL;
a service provider system, communicatively coupled to the server, to process the request for the data for the at least one service via the API based on the generated URL by discarding the one or more monitoring parameters for the monitoring system added to the URL and to retrieve the requested data based on the processed request; and
the monitoring system, communicatively coupled to the service provider system, to monitor the added one or more monitoring parameters of the URL by categorizing or filtering the received request and to output a monitoring report,
wherein the server transmits, via a communications network coupled to the server, the data retrieved by the processing of the request.

11. The system of claim 10, wherein the monitoring system categorizes or filters the request without parsing one or more terms of the URL for the API.

12. The system of claim 10, wherein the wherein the monitoring system categorizes or filters the request by a type of the at least one service.

13. The system of claim 10, wherein when the one or more monitoring parameters exceeds a predetermined URL length, the server generates a unique identifier to be used as the one or more monitoring parameters, and adds the generated unique identifier to the URL.

14. The system of claim 13, further comprising:
a storage device, communicatively coupled to the server, to store the generated unique identifier that includes the one or more generated monitoring parameters.

15. The system of claim 14, when the adding the one or more monitoring parameters exceeds a predetermined URL length and the one or more monitoring parameters have been previously generated, the server retrieves generated unique identifier from the storage device, and adds the generated unique identifier to the URL.

16. The system of claim 14, wherein the server generates the unique identifier using a hash function without synchronization with the storage device.

17. A system comprising:
a server having a hardware processor to receive a Uniform Resource Locator (URL) request including at least a first parameter defined in an Application Program Interface (API) provided by the server and at least a second parameter not defined in the API, wherein the second parameter is a monitoring parameter to be monitored by a monitoring system communicatively coupled to the server, to discard the second parameter prior to processing the URL request by the API, to retrieve data by processing the URL request by the API using the first parameter, and to transmit, via a communications network coupled to the server, the data retrieved by the processing the URL request; and
the monitoring system, communicatively coupled to the server, to categorize or filter the URL request for processing based upon the second parameter, and to monitor the categorized or filtered URL request as it is processed by the server and output a monitoring report.

18. The method of claim 17, wherein the monitoring system categorizes or filters the request by a type of service based on the second parameter.
